(19) United States
(12) Patent Application Publication
(10) Pub. No.: US 2023/0032084 A1
(43) Pub. Date: Feb. 2, 2023

(54) APPARATUS FOR CONTROLLING ELECTRONIC PARKING BRAKE SYSTEM

(71) Applicant: MANDO CORPORATION, Gyeonggi-do (KR)

(72) Inventors: Jung Rae HA, Gyeonggi-do (KR); Min Ho KIM, Gyeonggi-do (KR)

(21) Appl. No.: 17/964,837

(22) Filed: Oct. 12, 2022

Related U.S. Application Data
(63) Continuation of application No. PCT/KR2021/011893, filed on Sep. 2, 2021.

(30) Foreign Application Priority Data
Sep. 2, 2020 (KR) 10-2020-0111397

(51) Int. Cl. B60W 30/18; G07C 5/08

(52) U.S. Cl. CPC B60W 30/18109; G07C 5/0816; B60W 2510/186

(57) ABSTRACT

The present disclosure relates to a control unit of an electronic parking brake system, including: a plurality of driver circuits which are respectively connected to a first motor and a second motor for providing a driving force to an electronic parking brake to control the first motor and the second motor; a first micro control unit (MCU) which has a plurality of core processors and is connected to a first driver circuit and a second driver circuit receiving a first power according to a reception of an electric parking brake (EPB) switch signal; and a second MCU which has at least one core processor and is connected to a third driver circuit receiving a second power. The control unit can be applied to other exemplary embodiments.

### CROSS-REFERENCE TO RELATED APPLICATION

This application claims priority to and the benefit of Korean Patent Application No. 10-2020-0111397, filed on Sep. 2, 2020, the disclosure of which is incorporated herein by reference in its entirety.

### TECHNICAL FIELD

The present disclosure relates to a control unit of an electronic parking brake system

### BACKGROUND ART

Recently released vehicles use an electronic parking brake (EPB) device for electronically controlling the driving of a parking brake, and the EPB device is mounted on a conventional disc brake to perform a parking brake function.

The electronic parking brake system enables the driver to automatically activate or release the parking brake according to the control judgment of the electronic control unit (ECU), which performs a simple switch operation or overall control, even if the driver does not manually apply the parking brake. The electronic parking brake device is configured with an actuator for driving a motor generating a braking force and a micro control unit (MCU) for controlling the actuator.

Recently, as interest in autonomous and electric vehicles has increased, the brake system has also developed such as using an electronic master booster instead of a hydraulic system As a result, the integrated dynamic brake (IDB) system has been developed by integrating the anti-lock brake system (ABS) and the electric stability control (ESC) system. As such, the IDB system can control not only the service brake operated during general driving but also the parking brake, making it possible to reduce the size and weight of the brake system, and stability has also been significantly improved while providing various functions.

Since many parts of the IDB system are composed of electronic equipment, in order to increase the reliability of the operation of the electronic parking brake system, the ECU as described above includes a plurality of MCUs, and the main MCU controls all of a plurality of actuators among the plurality of MCUs. Accordingly, when a fault occurs in the main MCU, there is a problem in that the operation of the actuator cannot be controlled.

### DISCLOSURE

### Technical Problem

The exemplary embodiments of the present disclosure for solving these conventional problems provide a control unit of an electronic parking brake system, which additionally includes an actuator and drives the additionally included actuator by using the other MCU when a fault occurs in any one MCU among a plurality of MCUs.

In addition, the exemplary embodiments of the present disclosure provide a control unit of an electronic parking brake system in which a cut-off circuit is implemented in any one actuator.

### Technical Solution

The control unit of an electronic parking brake system according to an exemplary embodiment of the present disclosure includes a plurality of driver circuits which are respectively connected to a first motor and a second motor for providing a driving force to an electronic parking brake to control the first motor and the second motor, a first micro control unit (MCU) which is connected to a first driver circuit and a second driver circuit receiving a first power according to a reception of an electric parking brake (EPB) switch signal, and a second MCU which is connected to a third driver circuit receiving a second power.

In addition, the second driver circuit receives the first power when a first switch is turned on.

In addition, the third driver circuit receives the second power when a second switch is turned on.

In addition, the second switch is turned off when the first MCU operates normally.

In addition, the second MCU receives the EPB switch signal through in-vehicle communication when a fault occurs in the first MCU.

In addition, the third driver circuit further includes a cut-off switch for preventing a malfunction of the second MCU when the first MCU operates normally, wherein the cut-off switch is provided between a low arm and a ground of the third driver circuit.

In addition, the first MCU and the second MCU perform communication through a data bus.

In addition, the first driver circuit and the second driver circuit drive a first motor and a second motor, respectively

In addition, the third driver circuit drives the second motor.

In addition, the first MCU has a plurality of core processors, and the second MCU has at least one core processor.

In addition, the first MCU and the second MCU are implemented on separate PCBs.

In addition, the second MCU receives a P-lock switch signal through in-vehicle communication when a fault occurs in the first MCU, and turns on the second switch to control the third driver circuit.

In addition, the third driver circuit further includes a cut-off switch provided between a low arm and a ground of the third driver circuit, wherein the cut-off switch is turned on when a fault occurs in the first MCU.

In addition, the second MCU receives a WSS sensing signal through in-vehicle communication when a fault occurs in the first MCU, and turns on the second switch based on a wheel speed identified from the WSS sensing signal being 0 to control the third driver circuit

In addition, the third driver circuit further includes a cut-off switch provided between a low arm and a ground of the third driver circuit, wherein the cut-off switch is turned on when a fault occurs in the first MCU.

A controlling method of an electronic parking brake system wherein the electronic parking brake system comprises a first micro control unit (MCU) connected to a first driver circuit and a second driver circuit and a second MCU connected to a third driver circuit, comprises providing a first power to the first driver circuit and the second driver circuit according to a reception of an electric parking brake (EPB) switch signal, wherein the first driver circuit and the second driver circuit are respectively connected to a first motor and a second motor, controlling the first motor and the second motor for providing a driving force to an electronic parking brake, when a fault occurs in the first MCU, providing a second power to a third driver circuit connected to the second motor and controlling the second motor for providing a driving force to an electronic parking brake.

In addition, the providing the first power includes providing the first power to the second driver circuit when a first switch is turned on.

In addition, the providing the second power includes providing the second power to the third driver circuit when a second switch is turned on.

### Advantageous Effects

As described above, the control unit of the electronic parking brake system according to the present disclosure has the effect of securing the redundancy of the electronic parking brake system by further including an actuator and driving the additionally included actuator by using the other MCU when a fault occurs in any one MCU among a plurality of MCUs.

In addition, the control unit of the electronic parking brake system according to the present disclosure has the effect of preventing a malfunction in the other MCU by a cut-off circuit, when the cut-off circuit is implemented in any one actuator and a plurality of actuators are normally driven by any one MCU.

### DESCRIPTION OF DRAWINGS

FIG. 1 is a view showing the schematic structure of an electronic parking brake system according to an exemplary embodiment of the present disclosure.

FIG. 2 is a view showing the schematic structure of a braking device illustrated in FIG. 1.

FIG. 3 is a view showing the schematic configuration of an electronic parking brake system according to a first example of the present disclosure.

FIG. 4 is a view showing another operation path of the electronic parking brake system according to the first example of the present disclosure.

FIG. 5 is a view showing another operation path of the electronic parking brake system according to the first example of the present disclosure.

FIG. 6 is a view showing the schematic configuration of an electronic parking brake system according to a second example of the present disclosure.

### MODES OF THE INVENTION

The exemplary embodiments of the present disclosure are provided to more completely describe the present disclosure to those of ordinary skill in the art, and the exemplary embodiments described below may be modified in various other forms, and the scope of the present disclosure is not limited to the following exemplary embodiments. Rather, these exemplary embodiments are provided to describe the present disclosure more fully and completely and to fully convey the spirit of the present disclosure to those skilled in the art.

The terminology used herein is for the purpose of describing particular exemplary embodiments only and is not intended to be limiting the present disclosure. As used herein, the singular forms are intended to include the plural forms as well, unless the context clearly indicates otherwise. It will be further understood that when used in the present specification, the terms "comprise" and/or "comprising" specify the presence of stated features, numbers, steps, operations, elements and/or components, but do not preclude the presence or addition of one or more other features, numbers, steps, operations, elements, components and/or groups thereof. As used in the present specification, the term "and/or" includes any one and all combinations of one or more of those listed items.

Hereinafter, the exemplary embodiments of the present disclosure are described with reference to schematically illustrated views. As such, variations from the shapes of the illustrations as a result, for example, of manufacturing techniques and/or tolerances, are to be expected. Thus, the exemplary embodiments of the present disclosure should not be construed as limited to the particular shapes of regions illustrated herein, but are to include deviations in shapes that result, for example, from manufacturing.

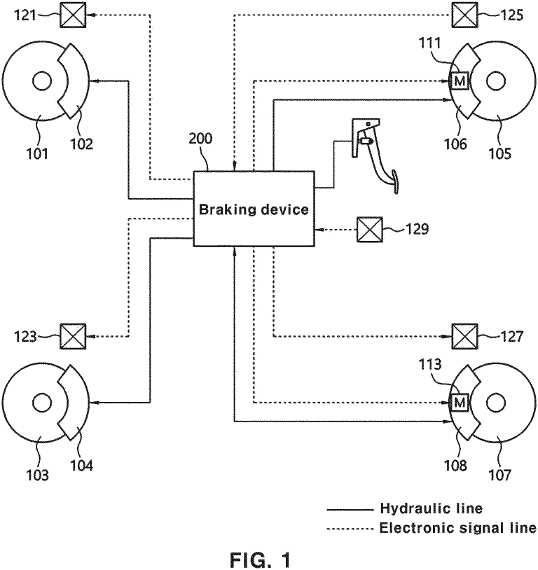

FIG. 1 is a view showing the schematic structure of an electronic parking brake system according to an exemplary embodiment of the present disclosure.

Referring to FIG. 1, the electronic parking brake system largely includes a brake pedal, vehicle wheels 101, 103, 105, 107, calipers 102, 104, 106, 108 for applying a braking force to each wheel 101, 103, 105, 107, wheel speed sensors (WSS) 121, 123, 125, 127 for checking the rotational speed of each wheel 101, 103, 105, 107, a PTS 129, motors 111, 113 for controlling the driving of a parking brake formed to be electronically operated through an external force on rear wheels 105 and 107 of the vehicle, and a braking device 200.

The first wheel 101 and the second wheel 103 are formed at the front of the vehicle, and when an external force is applied to the brake pedal on the first wheel 101 and the second wheel 103, a first caliper 102 and a second caliper 104 for applying a braking force to each wheel 101, 103 are formed. In addition, a third wheel 105 and a fourth wheel 107 are formed at the rear of the vehicle, and when an external force is applied to the brake pedal on the third wheel 105 and the fourth wheel 107, a third caliper 106 and a fourth caliper 108 for applying a braking force to each wheel 105, 107 are formed. In addition, when an external force is generated in an electric parking brake (EPB) switch, the first motor 111 and the second motor 113 for controlling the driving of the wheels 105 and 107 of the vehicle by driving the electronically operated parking brake are formed.

In addition, the WSSs 121, 123, 125, 127 check the wheel rotation speed to provide it to the braking device 200, and the PTS 129 is a pedal sensor, which detects an external force generated on the brake pedal from the outside of the vehicle to provide it to the braking device 200. The braking device 200 operates the calipers 102, 104, 106, 108 based on a signal provided from the PTS 129 to apply a braking force to each of the wheels 101, 103, 105, 107.

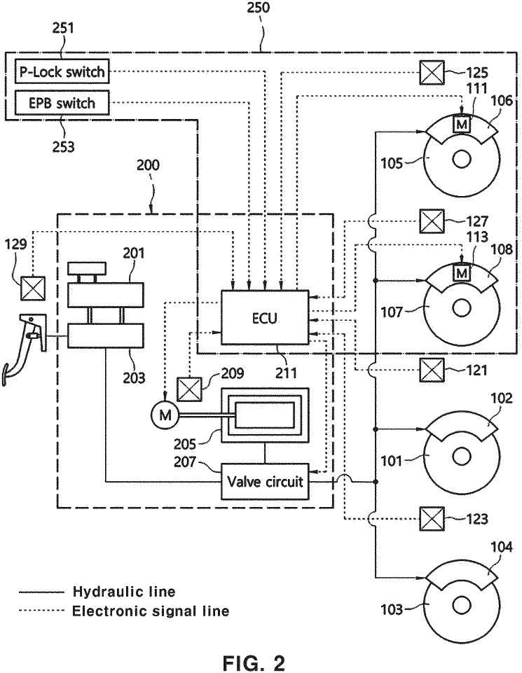

FIG. 2 is a view showing the schematic structure of a braking device illustrated in FIG. 1.

Referring to FIG. 2, the braking device 200 may largely include a reservoir 201, a master cylinder 203, a hydraulic pressure supply device 205, a valve circuit 207, an MPS 209 and an ECU 211.

The reservoir 201 stores a pressurized medium for generating pressure by flowing along the flow path. The pressurized medium flows to the required place according to the control of the valve. Although not illustrated, a simulator valve is created in the flow path of the reservoir 201 so as to control the flow of the pressurized medium between the reservoir 201 and the master cylinder 203. During normal operation, the simulator valve is open such that the user interlocks the reservoir 201 and the master cylinder 203, and in an abnormal mode, the simulator valve is closed such that the pressurized medium of the master cylinder 203 is transferred to valves for wheel cylinder control through a backup flow path.

The master cylinder 203 pressurizes and discharges a pressurized medium such as brake oil or the like, which is accommodated therein when the driver presses the brake pedal. As a result, this provides the driver with a reaction force according to the braking force. In addition, the PTS 129 senses an external force generated on the brake pedal from the outside of the vehicle and provides it to the ECU 211.

The hydraulic pressure supply device 205 generates hydraulic pressure according to the position of the pedal and transmits the hydraulic pressure to the wheel cylinders of the wheels 101, 103, 105, 107 such that the braking of the vehicle is performed. In order to generate hydraulic pressure, the hydraulic pressure supply device 205 includes a motor. In addition, the braking device 200 includes an MPS 209. The MPS 209 is a motor position sensor, which measures the exact rotational position of the motor included in the hydraulic pressure supply device 205 and provides it to the ECU 211.

The valve circuit 207 may control a plurality of relief valves for controlling the flow path between the hydraulic pressure supply device 205 and the wheel cylinder, a plurality of outlet valves for controlling the flow path between the master cylinder 203 and the wheel cylinder, a simulator valve for forming a pedal feeling, a cut valve for controlling a backup flow path between the master cylinder 203 and the wheel cylinder and the like.

Moreover, the ECU 211 receives sensing signals from a P-Lock switch 251, an EPB switch 253, a PTS 129, an MPS 209 and a plurality of WSSs 121, 123, 125, 127, and performs an operation corresponding to the provided sensing signal. More specifically, when the brake pedal is depressed by the driver, the PTS 129 detects the degree of the brake pedal being depressed, and the PTS 129 provides it to the ECU 211.

When the ECU 211 receives a P-lock switch signal through the P-lock switch 251 after the vehicle stops running, it activates the calipers 102, 104, 106, 108 which are respectively formed in a plurality of wheels 101, 103, 105, 107. More specifically, when the P-lock switch signal is received through the P-lock switch 251, the ECU 211 transmits a signal to control a plurality of relief valves that control the flow path between the hydraulic pressure supply device 205 and the wheel cylinder by the valve circuit 207.

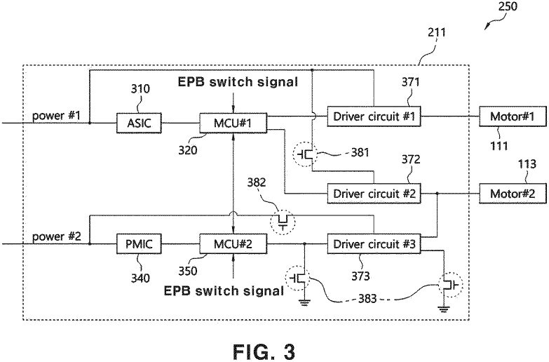

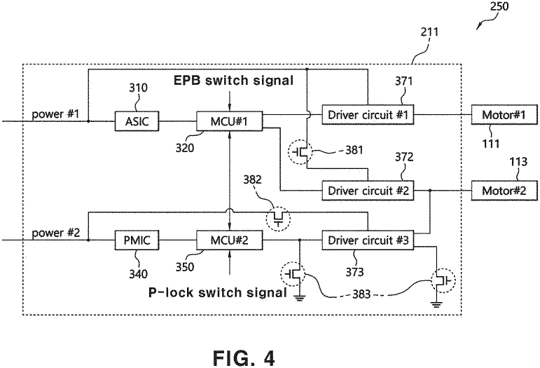

The ECU 211 receives the speed of the wheels 101, 103, 105, 107 from the WSS 121, 123, 125, and 127 to detect the parking state. In addition, when the ECU 211 receives a EPB switch signal through the EPB switch 253 after the vehicle stops running, it operates the first motor 111 and the second motor 113 for controlling the driving of the parking brake which is respectively formed in the third wheel 105 and the fourth wheel 107 formed at the rear of the vehicle, respectively. As described above, various examples of securing vehicle redundancy by using the electronic parking brake system 250 including the ECU 211 will be described in detail with reference to FIGS. 3 to 4 below.

FIG. 3 is a view showing the schematic configuration of an electronic parking brake system according to a first example of the present disclosure.

Referring to FIG. 3, the electronic parking brake system 250 according to the first example of the present disclosure may include an ECU 211 and motors 111, 113. The ECU 211 includes an ASIC 310, a first MCU 320, a first driver circuit 371, a second driver circuit 372, a PMIC 340, a second MCU 350 and a third driver circuit 373. The first driver circuit 371 and the second driver circuit 372 are one component of an actuator that drives a motor that generates a braking force in the wheels 101, 103, 105, 107. Although not illustrated, the first MCU 320 and the second MCU 350 respectively include an MCU and a motor driver IC. In addition, the MCU included in the first MCU 320 may have a plurality of core processors, and the MCU included in the second MCU 350 may be implemented with at least one core processor. In addition, the first MCU 320 and the second MCU 350 may be implemented and operated on separate printed circuit boards (PCB).

The PMIC 340 includes a WD counter (hereinafter, referred to as WD). The WD detects the operation of the second MCU 350. When the second MCU 350 is a multi-core processor, the PMIC 340 may not include the WD. In addition, the first driver circuit 371 is connected to the first motor 111, and the second driver circuit 372 and the third driver circuit 373 are connected to the second motor 113.

The ASIC 310 and the PMIC 340 are supplied with power from the vehicle's battery. In this case, the ASIC 310 may receive a first power, and the PMIC 340 may receive a second power. The first power and the second power may be output from the same battery or may be output from different batteries, and the voltages of the first power and the second power may be the same or different. The ECU 211 may include a transformer (not illustrated) which is capable of making the voltages of the first power and the second power output from the same battery different.

The ASIC 310 supplies power to the first MCU 320 based on the first power, and the PMIC 340 supplies power to the second MCU 350 based on the second power. Moreover, the first power is supplied to the first driver circuit 371 and the second driver circuit 372, and the second power is supplied to the third driver circuit 373.

When the first MCU 320 operates normally, the first switch 381 connecting a power line providing the first power and the second driver circuit 372 maintains an on state. When the first MCU 320 operates normally, the motor driver IC included in the first MCU 320 receives an EPB switch signal generated from the EPB switch.

When the EPB switch signal is received, the first MCU 320 provides the received EPB switch signal to the first driver circuit 371 and the second driver circuit 372 connected to the first MCU 320. Accordingly, the first driver circuit 371 and the second driver circuit 372 control the operation of the respectively connected first motor 111 and second motor 113 so as to apply a driving force to the electronic parking brake provided in the rear wheel of the vehicle.

As such, when the first MCU 320 is normally operated, the second switch 382 connecting a power line providing the second power and the third driver circuit 373 maintains an off state, and the cut-off switch 383 connected between a low arm and a ground of the third driver circuit 373 maintains an off state. Through this, by preventing the second MCU 350 and the third driver circuit 373 from being connected to each other, it is possible to prevent a malfunction in which the second MCU 350 is driven when the first MCU 320 operates normally.

The first MCU 320 and the second MCU 350 communicate periodically or in real time through a data bus. Through this, the second MCU 350 checks whether a fault has occurred in the first MCU 320. When a fault occurs in the first MCU 320, the second switch 382 connecting a power line providing the second power and the third driver circuit 373 is changed to an on state, and the cut-off switch 383 is changed to an on state.

The second MCU 350 receives an EPB switch signal through CAN communication when it is confirmed that a fault has occurred in the first MCU 320. In this case, the reception of the EPB switch signal is received by the motor driver IC included in the second MCU 350. When the EPB switch signal is received, the second MCU 350 provides the EPB switch signal to the third driver circuit 373. Accordingly, the second motor 113 connected to the third driver circuit 373 operates to provide a driving force to the electronic parking brake connected to the second motor 113. Through this, even if a fault occurs in the first MCU 320, it is possible to secure the redundancy of the parking brake.

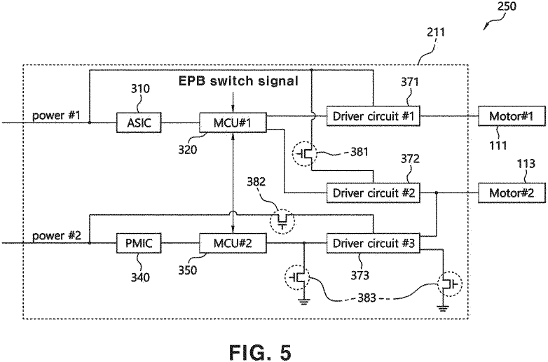

FIGS. 4 and 5 describe an additional example of a redundancy system in which the second MCU 350 operates when a fault occurs in the first MCU 320 in the electronic parking brake system 250 according to the first example.

In FIG. 4, when a fault occurs in the first MCU 320, the second switch 382 connecting a power line providing the second power and the third driver circuit 373 is changed to an on state, and the cut-off switch 383 is changed to an on state. The second MCU 350 may be connected to the P-lock switch 251 described with reference to FIG. 2. The second MCU 350 receives a P-lock switch signal from the P-lock switch 251, and the second motor 113 connected to the third driver circuit 373 operates based on the received P-lock switch signal to provide a driving force to the electronic parking brake connected to the second motor 113. Through this, even if a fault occurs in the first MCU 320, it is possible to secure the redundancy of the parking brake.

In FIG. 5, when a fault occurs in the first MCU 320, the second switch 382 connecting a power line providing the second power and the third driver circuit 373 is changed to an on state, and the cut-off switch 383 is changed to an on state. The second MCU 350 receives a WSS sensing signal including the speeds of the wheels 101, 103, 105, 107 of the vehicle from the WSSs 121, 123, 125, 127 described with reference to FIG. 2. When the second MCU 350 identifies that the wheel speed received from the WSS is 0, the second motor 113 connected to the third driver circuit 373 operates to provide a driving force to the electronic parking brake connected to the second motor 113. Through this, even if a fault occurs in the first MCU 320, it is possible to secure the redundancy of the parking brake.

Moreover, in the first example of the present disclosure, the first switch 381, the second switch 382 and the cut-off switch 383 are described as examples of a field effect transistor (FET) that operates on/off, but the present disclosure is not limited thereto and may be implemented as a relay switch.

According to an exemplary embodiment of the present disclosure, in the normal operating state, the first MCU 320 may perform two-channel motor operation by driving the first driver circuit 371 and the second driver circuit 372, and in emergency situations such as when a fault occurs in the MCU 320, it is possible to perform one-channel motor operation connecting the third driver circuit 373 of the second MCU 350. In addition, when the second motor 113 is driven through the third driver circuit 373 connected to the second MCU 350, since it is not connected to other driver circuits, it is possible to eliminate the complicated switch design of a bridge circuit.

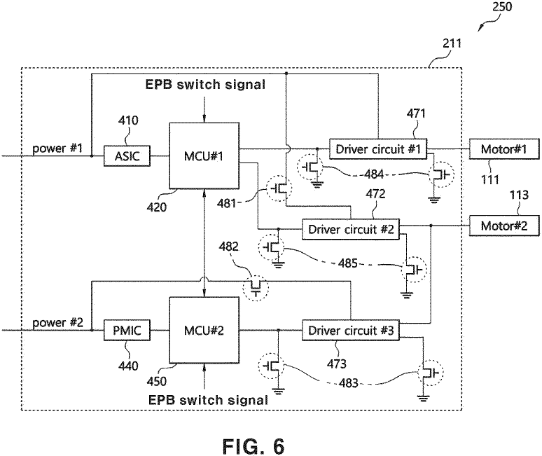

FIG. 6 is a view showing the schematic configuration of an electronic parking brake system according to a second example of the present disclosure.

Referring to FIG. 6, the electronic parking brake system 250 according to the second example of the present disclosure may include an ECU 211 and motors 111, 113. The ECU 211 includes an ASIC 410, a first MCU 420, a first driver circuit 471, a second driver circuit 472, a PMIC 440, a second MCU 450 and a third driver circuit 473. In this case, the ECU 211 is different from the ECU 211 described in the first example in that the first driver circuit 471 and the second driver circuit 472 additionally include cutoff switches 484, 485, respectively. However, other components and operations are the same as and very similar to those of the first example. Accordingly, only the configurations and operations that are different from those of the first example will be described.

When the first MCU 420 operates normally, the first switch 481 connecting a power line providing the first power and the second driver circuit 472 maintains an on state. When the first MCU 420 operates normally, the motor driver IC included in the first MCU 420 receives an EPB switch signal generated from the EPB switch. When the first MCU 420 receives the EPB switch signal, the first MCU 420 provides the EPB switch signal to the first driver circuit 471 and the second driver circuit 472 connected to the first MCU 420. Accordingly, the first driver circuit 471 and the second driver circuit 472 control the operation of the respectively connected first motor 111 and second motor 113 so as to apply a driving force to the electronic parking brake provided in the rear wheel of the vehicle. As such, when the first driver circuit 471 and the second driver circuit 472 operate normally, each of the cut-off switches 484, 485 connected between the low arm and the ground of the first driver circuit 471 and the second driver circuit 472 maintain an on state.

The first MCU 420 and the second MCU 450 communicate periodically or in real time through a data bus. Through this, the second MCU 450 checks whether a fault has occurred in the first MCU 420. When a fault occurs in the first MCU 420, the second switch 482 connecting a power line providing the second power and the third driver circuit 473 is changed to an on state, and the cut-off switch 483 is changed to an on state. Further, in order to prevent the first driver circuit 471 and the second driver circuit 472 from malfunctioning while the third driver circuit 473 is operating, each of the cut-off switches 484, 485 connected to the first driver circuit 471 and the second driver circuit 472 maintains an off state.

Moreover, in the second example of the present disclosure, the first switch 481, the second switch 482 and the cut-off switches 483, 484, 485 are described as examples of a field effect transistor (FET) operating in on/off, but the present disclosure is not necessarily limited thereto and may be implemented as a relay switch.

Further, in the first and second examples of the present disclosure, if the vehicle is restarted after operating the second MCUs 350, 450 when a fault occurs in the first MCUs 320, 420, it checks the status of the first MCUs 320, 420. If the first MCUs 320, 420 are normal, the cut-off switches 383, 483 are turned off. However, if the first MCUs 320, 420 are still in a faulty state even after the vehicle is restarted, the operation of the third driver circuits 373, 473 must be controlled, and thus, the cut-off switches 383, 483 may be continuously maintained in an on state. However, this may be applied differently according to the requirements of the manufacturer.

It will be apparent to those of ordinary skill in the art that the present disclosure is not limited to the above exemplary embodiments and may be implemented with various modifications and variations without departing from the technical gist of the present disclosure.

1. A control unit of an electronic parking brake system, comprising:
a plurality of driver circuits which are respectively connected to a first motor and a second motor for providing a driving force to an electronic parking brake to control the first motor and the second motor;
a first micro control unit (MCU) which is connected to a first driver circuit and a second driver circuit receiving a first power according to a reception of an electric parking brake (EPB) switch signal; and
a second MCU which is connected to a third driver circuit receiving a second power.

2. The control unit of claim 1, wherein the second driver circuit receives the first power when a first switch is turned on.

3. The control unit of claim 2, wherein the third driver circuit receives the second power when a second switch is turned on.

4. The control unit of claim 3, wherein the second switch is turned off when the first MCU operates normally.

5. The control unit of claim 3, wherein the second MCU receives the EPB switch signal through in-vehicle communication when a fault occurs in the first MCU.

6. The control unit of claim 5, wherein the third driver circuit further comprises:
a cut-off switch for preventing a malfunction of the second MCU when the first MCU operates normally,
wherein the cut-off switch is provided between a low arm and a ground of the third driver circuit.

7. The control unit of claim 1, wherein the first MCU and the second MCU perform communication through a data bus.

8. The control unit of claim 6, wherein the first driver circuit and the second driver circuit drive a first motor and a second motor, respectively.

9. The control unit of claim 6, wherein the third driver circuit drives the second motor.

10. The control unit of claim 1, wherein the first MCU has a plurality of core processors, and
wherein the second MCU has at least one core processor.

11. The control unit of claim 1, wherein the first MCU and the second MCU are implemented on separate PCBs.

12. The control unit of claim 3, wherein the second MCU receives a P-lock switch signal through in-vehicle communication when a fault occurs in the first MCU, and turns on the second switch to control the third driver circuit.

13. The control unit of claim 12, wherein the third driver circuit further comprises:
a cut-off switch provided between a low arm and a ground of the third driver circuit,
wherein the cut-off switch is turned on when a fault occurs in the first MCU.

14. The control unit of claim 3, wherein the second MCU receives a WSS sensing signal through in-vehicle communication when a fault occurs in the first MCU, and turns on the second switch based on a wheel speed identified from the WSS sensing signal being 0 to control the third driver circuit.

15. The control unit of claim 14, wherein the third driver circuit further comprises:
a cut-off switch provided between a low arm and a ground of the third driver circuit,
wherein the cut-off switch is turned on when a fault occurs in the first MCU.

16. A controlling method of an electronic parking brake system wherein the electronic parking brake system comprises a first micro control unit (MCU) connected to a first driver circuit and a second driver circuit and a second MCU connected to a third driver circuit, comprising:
providing a first power to the first driver circuit and the second driver circuit according to a reception of an electric parking brake (EPB) switch signal, wherein the first driver circuit and the second driver circuit are respectively connected to a first motor and a second motor,
controlling the first motor and the second motor for providing a driving force to an electronic parking brake,
when a fault occurs in the first MCU, providing a second power to a third driver circuit connected to the second motor and controlling the second motor for providing a driving force to an electronic parking brake.

17. The controlling method of claim 16, wherein the providing the first power includes providing the first power to the second driver circuit when a first switch is turned on.

18. The controlling method of claim 17, wherein the providing the second power includes providing the second power to the third driver circuit when a second switch is turned on.

19. The controlling method of claim 18, wherein the second switch is turned off when the first MCU operates normally.

20. The controlling method of claim 18, wherein the second MCU receives the EPB switch signal through in-vehicle communication when the fault occurs in the first MCU.
